(19) United States
(12) Patent Application Publication
(10) Pub. No.: US 2009/0289464 A1
(43) Pub. Date: Nov. 26, 2009

(54) Door Cover

(76) Inventor: David Pawson, Plano, TX (US)

Correspondence Address: WILSON DANIEL SWAYZE, JR., 3804 CLEARWATER CT., PLANO, TX, 75025, US

(21) Appl. No.: 12/126,952

(22) Filed: May 26, 2008

(51) Int. Cl. E05B 17/14

(52) U.S. Cl. 292/346

(57) ABSTRACT

A cover for a portion of a door may include a front planar plate having a front surface and a back surface, the back surface including a first outward projection member and a second outward projection member and a rear planar plate having a first aperture and the second aperture to cooperate with the first outward projection member and the second outward projection member respectively. The first aperture may extend through the rear planar plate, and the second aperture may extend through the rear planar plate. The front face of the front planar plate may include a beveled edge around the periphery of the front planar plate, and the back face of the back planar plate may include a beveled edge around the periphery of the back planar plate. The first outward leg projection member may include a center aperture, and the second outward projection member may include a center aperture. The center aperture of the first outward projection member may include internal threads. The center aperture of these second outward projection member may include internal threads, and the front surface of the front planar plate may include indicia.

### FIELD OF THE INVENTION

The present invention relates to a lock set installation and, more particularly, to an apparatus to cover holes left by a jig and to cover bore holes in a door after a lock set assembly has been removed.

Installation jigs to install lock sets are known in the art. Examples of such jigs are illustrated in U.S. Pat. No. 6,398,465 to Monge and U.S. Pat. No. 2,763,299 to Cerf. The Monge patent illustrates an installation jig which includes a pair of jaws and a latch guide coupled together by an adjusting mechanism. The latch guide is somewhat complicated, however, it appears to work satisfactory for its intended purpose. The patent to Cerf illustrates a lock installation tool which only provides for a single back set. While these patents provide satisfactory apparatus, designers are always striving to improve the art.

U.S. Pat. No. 7,210,880 discloses a lock set installation apparatus having a pair of hole saw guides which locate a hole to receive door operating members of a lock set. Each hole saw guide has at least one rail member which oppose one another. A lock bolt hole mechanism is movable and coupled with the rails. The lock bolt hole mechanism centers the lock bolt hole onto the door. A locking mechanism locks the hole saw guides with respect to one another to enable cutting of the door.

When a “cypher lock” or “push-button” lock set is removed from the door to be replaced by a cylindrical lock set, unsightly holes required for mounting the “cypher lock” must be covered. This is most commonly accomplished through the installation of a “wrap-around” plate for which the door must frequently be mortised and which is secured in place by additional screws, further marring the surface of the door. Further adjustments to the door may be needed to reinstall second “cypher lock,” is desired to be installed the door. Brand names of common “cypher locks” include Trilogy (by Alarm Lock) and Unican (by Simplex).

### SUMMARY

A cover for a portion of a door may include a front planar plate having a front surface and a back surface, the back surface including a first outward projection member and a second outward projection member and a rear planar plate having a first aperture and the second aperture to cooperate with the first outward projection member and the second outward projection member respectively.

The first aperture may extend through the rear planar plate, and the second aperture may extend through the rear planar plate.

The front face of the front planar plate may include a beveled edge around the periphery of the front planar plate, and the back face of the back planar plate may include a beveled edge around the periphery of the back planar plate.

The first outward leg projection member may include a center aperture, and the second outward projection member may include a center aperture.

The center aperture of the first outward projection member may include internal threads.

The center aperture of these second outward projection member may include internal threads, and the front surface of the front planar plate may include indicia.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a door profile for installation of the wrap around plate;

FIG. 2 illustrates a portion of a wrap around plate;

FIG. 3 illustrates another portion of the wrapped around plate;

FIG. 4 illustrates a partially compete full mortised lockstep with a wraparound plate mounted on the door;

FIG. 5 illustrates trim for the full mortised lock set;

FIG. 6 illustrates a perspective view of the full mortised lock set with a wraparound plate mounted on the door;

FIG. 7 illustrates another perspective view of the full mortised lock set with a wraparound plate mounted on the door;

FIG. 8 illustrates a cross-sectional view of a portion of the door with an uninstalled cipher lock set;

FIG. 9 illustrates a perspective view of a portion of the door that that may cover the cover plate;

FIG. 10 illustrates a perspective view of the front surface of the front planar plate member;

FIG. 11 illustrates a perspective view of the front surface of the back planar plate member

FIG. 12 illustrates a cipher lock set;

FIG. 13 illustrates a door with the cipher lock set replaced by a standard cylinder lock;

FIG. 14 illustrates the door preparation required to mount a wraparound cover plate designed to cover the holes left by a cipher lock;

FIG. 15 illustrates a cylinder lock and wraparound cover plate fully mounted on the door;

FIG. 16 illustrates a cylinder lock with the cover plate of the present invention.

### DETAILED DESCRIPTION

This design for a cover plate of the present invention utilizes the existing mounting holes required by the “cypher lock” without requiring adjustments to the door. Furthermore, if in the future a second “cypher lock” again becomes desirable on the door, simple removal of this cover plate allows the installation of the new “cypher lock” without additional retrofitting. The cover plate may be made with a plain surface or with any of a number of embossed messages, such as “Private Office” or “Exit Only.” The plate would be available in the finishes commonly employed by lock set manufacturers. For decorative purposes, the plate may also be made in shapes other than rectangular, for instance, an octagon (stop sign) or shield.

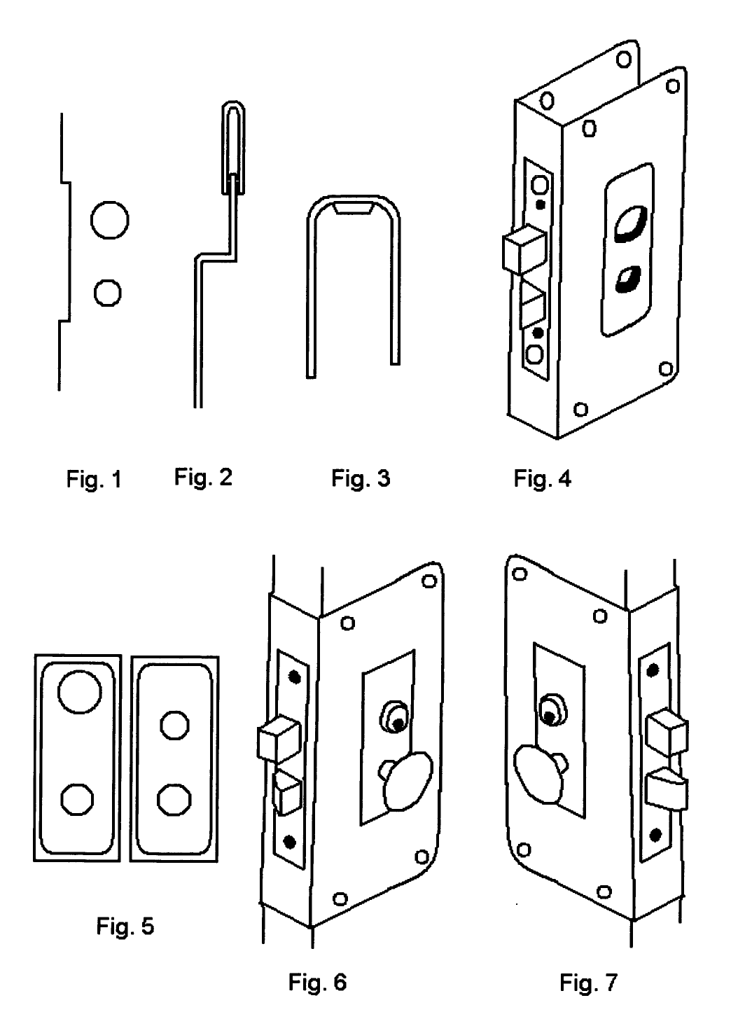

FIGS. 1-7 illustrate the procedure for installing a door lock. In FIG. 1, the old door lock is removed from the door. FIG. 1 shows how the door edge is cut to be centered on the lock. FIG. 2 illustrates that 2 screw fasteners are installed into the recessed areas with the lip facing down.

FIG. 3 determines which side is long, and the unit is placed on the flat surface. The long side is placed on the high edge of the door bevel.

FIG. 4 illustrates that the lock unit should be installed with the cylinder hole at the top, using screws.

For sectional trim, select the proper insert and place it into the large rectangular hole between the door and underside of the insert with the raised area facing out. Install the cylinder and knobs to hold the lock in place. Check to see that the lock matches the strike and be sure the lock is tight against the door.

For escutcheon trim, the unit is placed on the door. The cylinder and knob assembly is installed to hold the lock in place. The retaining screws are not installed this time. The lock should be tight against the edge of the door.

For both types of trim, the door is marked and drilled for the top mounting hole closest to the edge of the door and the through bolt is installed. This procedure is repeated on the bottom outside hole closest to the edge of the door. The door is drilled and the remaining two through bolts are installed. Now the escutcheon screws are installed.

The cipher lock set is intended to be permanently installed on the door. However, situations arise when it is necessary to remove the cipher lock set. Under these circumstances, it may be necessary to patch the holes left by the installation of the cipher lock set. The installation of plugs into the holes is generally not satisfactorily because it is nearly impossible to match the finish of the door.

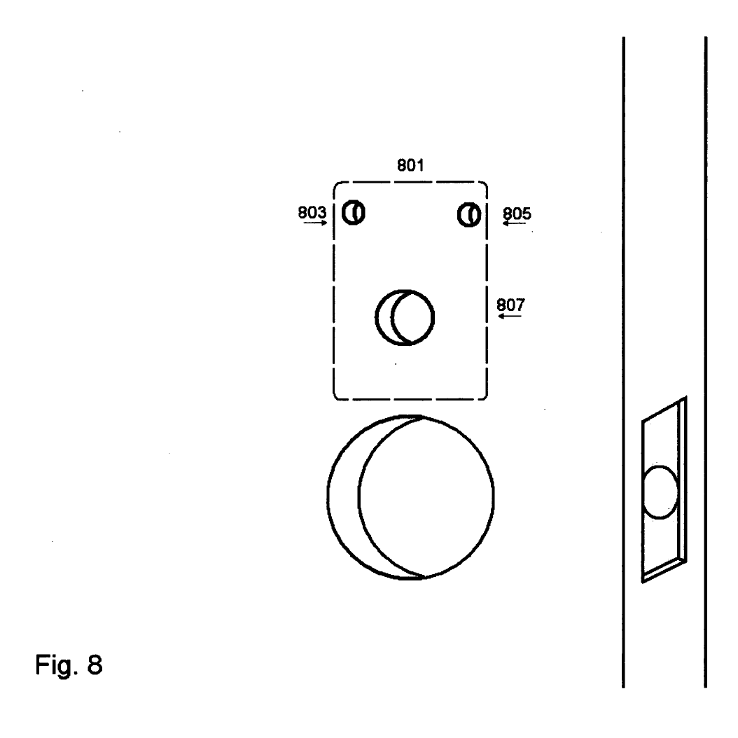

FIG. 8 illustrates a portion 801 of the door that has had a previous cipher lock set installed and removed. FIG. 8 illustrates a first retainer hole 803 and a second retainer hole 805 that was used by the retaining screws or bolts of the cipher lock set. FIG. 8 additionally illustrates a third cylinder hole 807 for the cylinder of the cipher lock set.

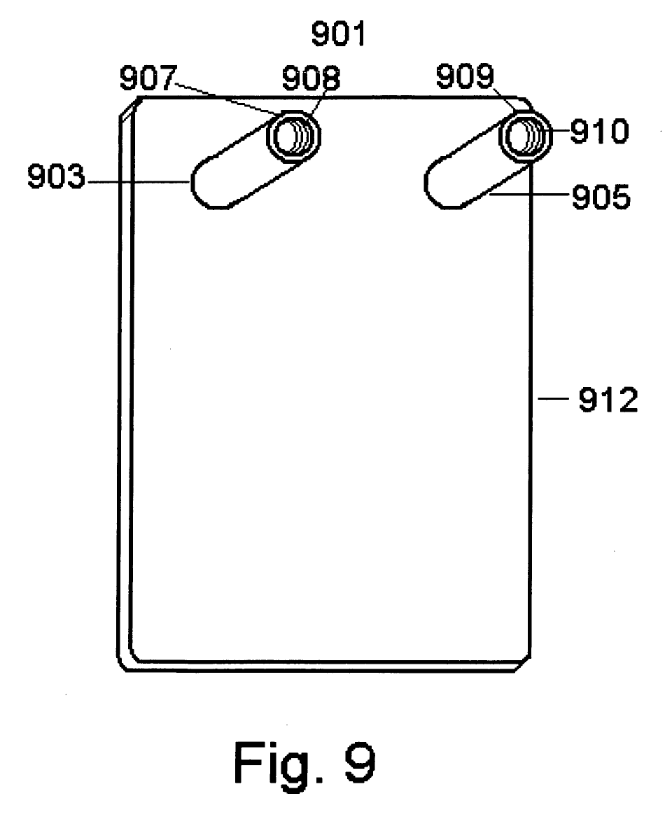

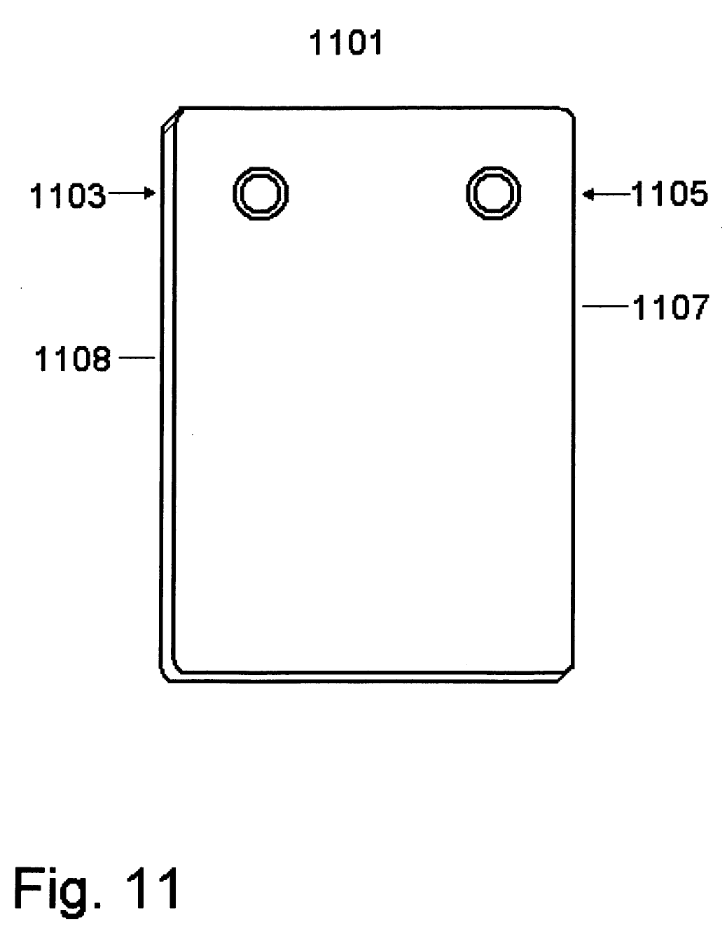

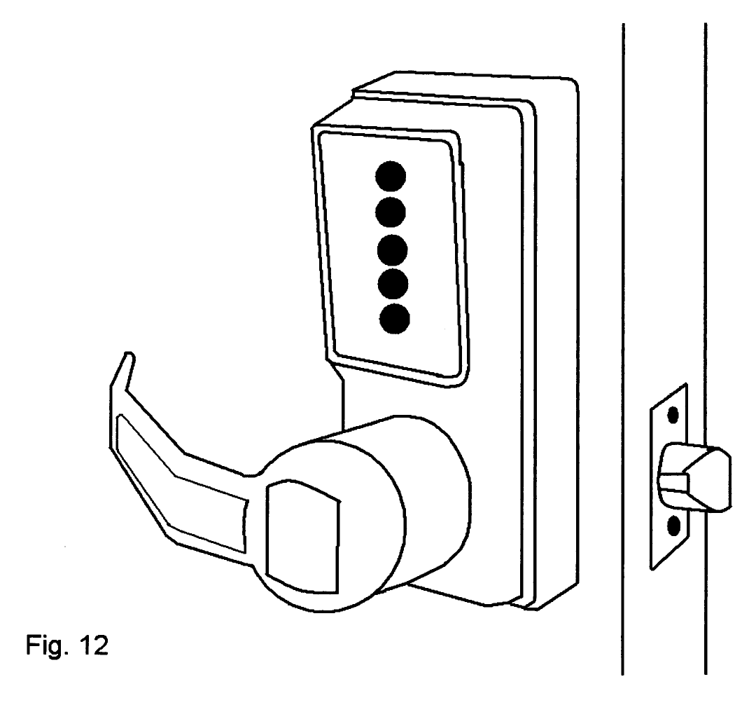

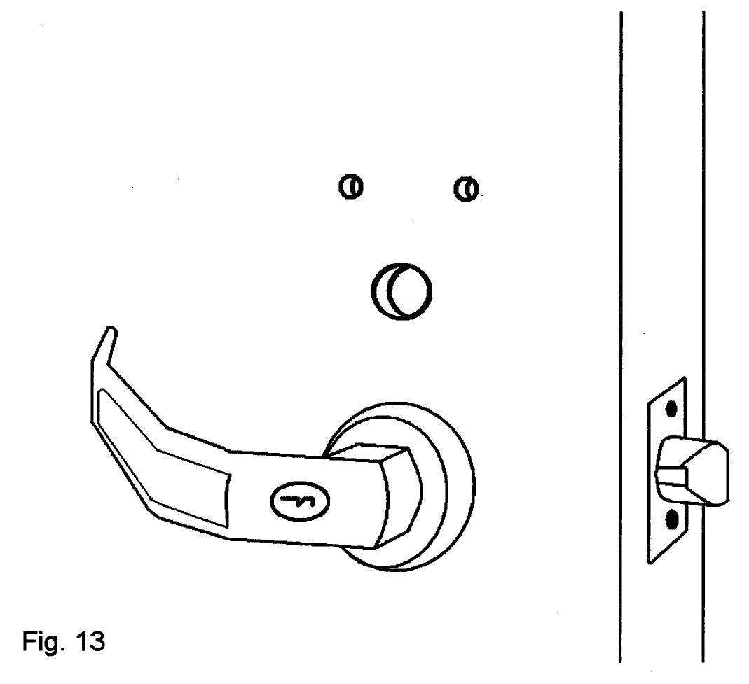

FIG. 9 illustrates a cover member 900 for covering the portion 801 of the door that has had a previous cipher lock set installed and removed. The cover member 900 includes a front planar plate 901 to cover the front portion 801 of the door. FIG. 9 illustrates the back surface 912 of the front planar plate 901. The front plate 901 includes a first outward protrusion member 903 which extends outward from the back surface 912 and is of sufficient length to extend through the portion 801 of the door and cooperate with the back planar plate 1107 as shown in FIG. 11. The front plate 901 additionally includes a second outward protrusion member 905 which extends outwards from the back surface 912 and is of sufficient length to extend through a portion 801 of the door to cooperate with the back planar plate 1107. The first and second outward protrusion members 903, 905 are shown as being substantially cylindrical in shape, but could be other shapes such as triangular rectangular or any other suitable shape. The first and second outward protrusion members 903, 905 include a first central aperture 908 and a second central aperture 910 respectively. The first central aperture 908 and the second central aperture 910 include a first internal thread 907 and second internal thread 909 in order to accept a fastening device such as screws.

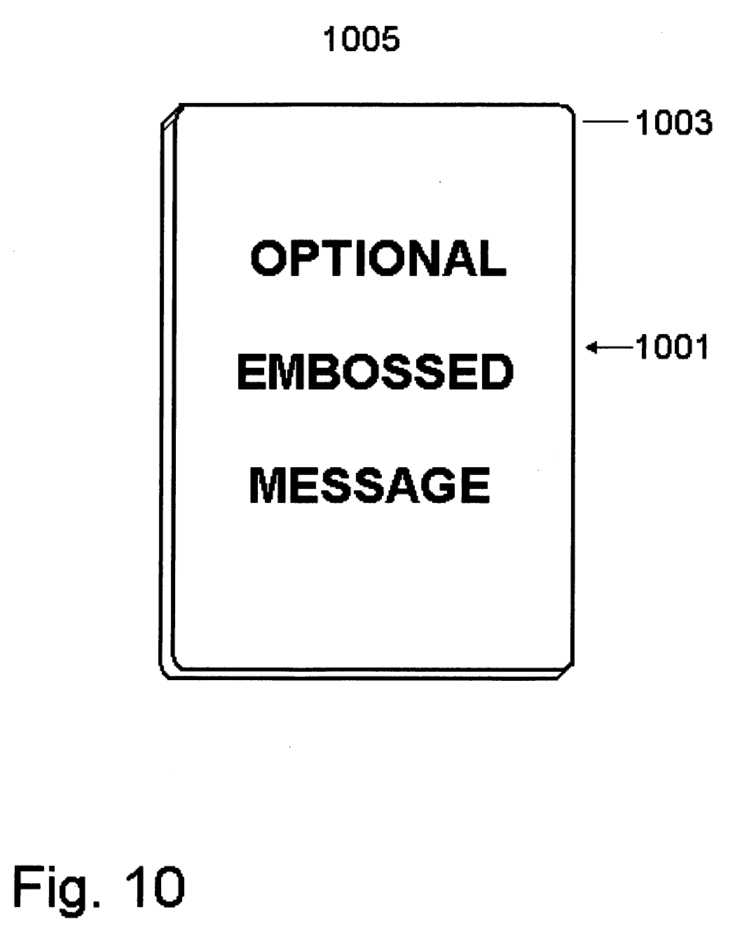

FIG. 10 illustrates the front surface 1005 of the front planar plate 901 which may include a beveled edge 1003 around the periphery of the front surface 1005. FIG. 10 additionally illustrates at the front surface 1005 includes indicia 1001 to provide an optional embossed message such as but not limited to private entry, restricted entry, no entry, private office, employees only and do not enter. Other messages are within the scope of the invention.

FIG. 11 illustrates the outer surface 1107 of the back planar plate 1101 which may be mounted on the portion 801 of the door, and the back planar plate 1101 is mounted on an opposing side of the portion 801 of the door. The back planar plate 1101 may include a bevel edge 1108 around the periphery of the back planar plate 1107. The back planar plate 1101 includes a first and second aperture 1103, 1105 through the back planar plate 1101 to cooperate with the first outward protrusion member 903 and the second outward protrusion member 905 to allow fasteners such as screws to fastened the front planar plate 901 to the back planar plate 1107 between the door.

FIG. 13 illustrates a door with the cipher lock set replaced by a standard cylinder lock;

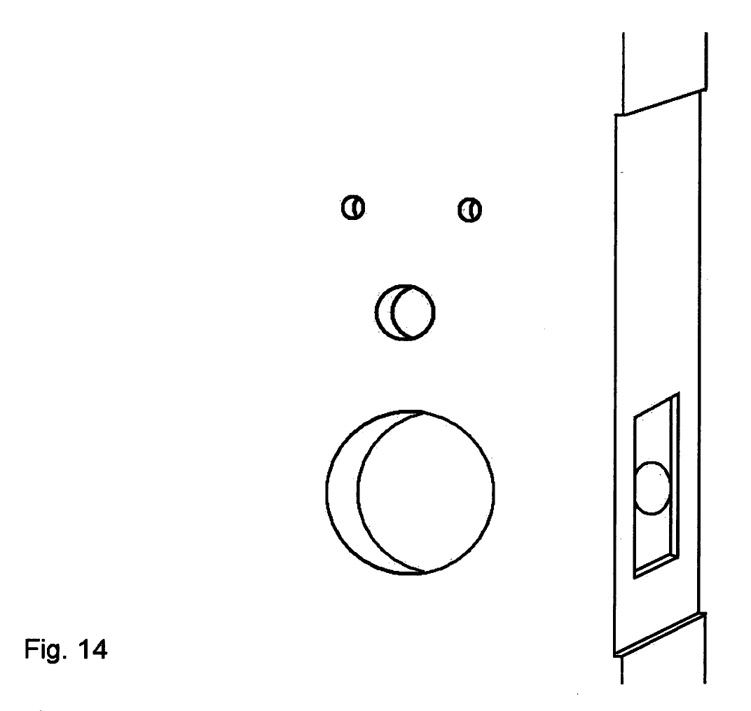

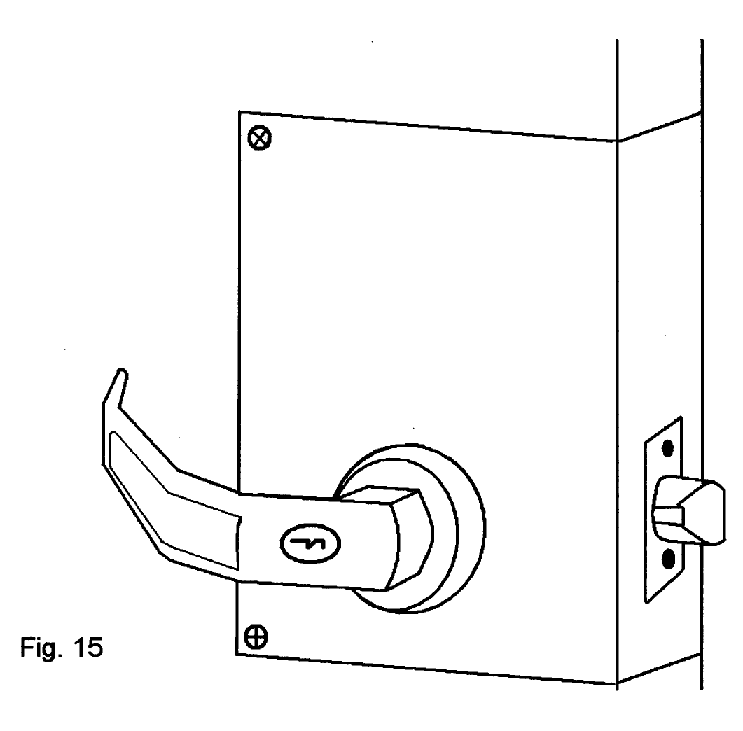

FIG. 14 illustrates the door preparation required to mount a wraparound cover plate designed to cover the holes left by a cipher lock;

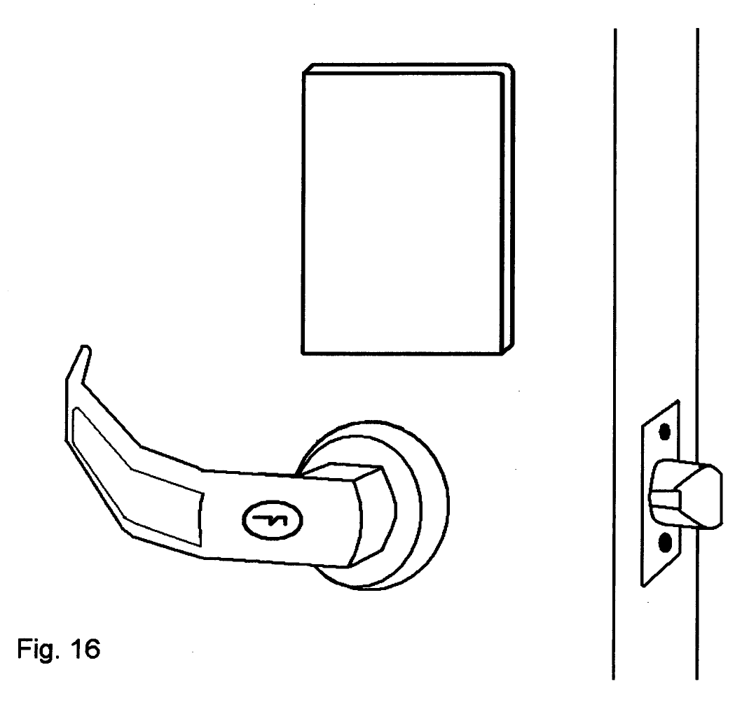

FIG. 15 illustrates a cylinder lock and wraparound cover plate fully mounted on the door;

FIG. 16 illustrates a cylinder lock with the cover plate of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A cover for a portion of a door, comprising:
a front planar plate having a front surface and a back surface, the back surface including a first outward projection member and a second outward projection member;
a rear planar plate having a first aperture and the second aperture to cooperate with the first outward projection member and the second outward projection member respectively.

2. As in claim 1, wherein the first aperture extends through the rear planar plate.

3. As in claim 1, wherein the second aperture extends through the rear planar plate.

4. As in claim 1, wherein the front face of the front planar plate includes a beveled edge around the periphery of the front planar plate.

5. As in claim 1, wherein the back face of the back planar plate includes a beveled edge around the periphery of the back planar plate.

6. As in claim 1, wherein the first outward leg projection member includes a center aperture.

7. As in claim 1, wherein the second outward projection member includes a center aperture.

8. As in claim 6, wherein the center aperture of the first outward projection member includes internal threads.

9. As in claim 1, wherein the center aperture of these second outward projection member includes internal threads.

10. As in claim 1, wherein the front surface of the front planar plate includes indicia.
